(19) United States
(12) Patent Application Publication
(10) Pub. No.: US 2008/0023899 A1
(43) Pub. Date: Jan. 31, 2008

(54) CYLINDRICAL VIBRATION-DAMPING DEVICE AND METHOD OF PRODUCING THE SAME, AND VIBRATION-DAMPING STRUCTURE INCLUDING THE CYLINDRICAL VIBRATION-DAMPING DEVICE

(75) Inventors: Koichi HASEGAWA, Kasugai-shi (JP); Atsushi MURAMATSU, Komaki-shi (JP)

Correspondence Address: ROSSI, KIMMS & McDOWELL LLP., P.O. BOX 826, ASHBURN, VA, 20146-0826, US

(73) Assignee: TOKAI RUBBER INDUSTRIES, LTD., Komaki-shi (JP)

(21) Appl. No.: 11/829,895

(22) Filed: Jul. 28, 2007

(30) Foreign Application Priority Data
Jul. 28, 2006 (JP) 2006-206403

(51) Int. Cl. F16F 15/08

(52) U.S. Cl. 267/141.1; 264/500; 267/140.11

(57) ABSTRACT

Disclosed is a method of producing an impact-type cylindrical vibration-damping device comprising the steps of: preparing a main rubber elastic body of hollow cylindrical shape including a mass installation groove open in an outer circumferential surface thereof and a slit extending over an entire axial length thereof; expanding the elastic body at the slit in order to mount the elastic body about a rod shaped vibrating member through the slit from a radially outer side such that the elastic body has an abutting inner surface adapted to come into abutting contact against the vibrating member at a portion where a radial distance between an inner circumferential surface of the elastic body and an outer circumferential surface of the vibrating member is smallest; preparing a mass member separately from the elastic body; and fixing the mass member to the elastic body by fitting the mass member onto the mass installation groove.

### INCORPORATED BY REFERENCE

The disclosure of Japanese Patent Application No. 2006-206403 filed on Jul. 28, 2006 including the specification, drawings and abstract is incorporated herein by reference in its entirety.

### BACKGROUND OF THE INVENTION

1. Field of the Invention

The present invention relates to a cylindrical vibration-damping device adapted to be mounted on hollow or solid rod shaped vibrating members such as a variety of shafts, arms and pipes, and capable of exhibiting vibration damping action against vibrations excited in the vibrating members due to vibration transmitted therethrough. The present invention also relates to a method of producing the above-described vibration-damping device; and a vibration-damping structure including the cylindrical vibration-damping device.

2. Description of the Related Art

A variety of rod shaped vibrating members including power transmitting members such as shafts, arms and beams as well as pipes forming fluid passages are likely to cause problems of resonance themselves and vibration transmission therethrough. Known measures for these problems are: (a) a mass damper in which a pillar-shaped mass member is fixed to a vibrating member; (b) a dynamic damper in which a pillar-shaped mass member is supported by and connected to the vibrating member via a spring member (see JP-A-2004-92674); and (c) a damping material which is a sheet-shaped elastic member and secured to the vibrating member.

However, these conventional devices suffer from various potential problems. For instance, the mass damper and the dynamic damper require a relatively large mass of the pillar-shaped mass member, and exhibit damping effects limited to a considerably narrow frequency range. The damping material requires a relatively large space for its installation, and tends to be large in its weight. In addition, the dynamic damper suffers from difficulty in stably exhibiting desired damping effects thereof, since the damping effects of rubber material which constitutes a spring member of a mass-spring system of the dynamic damper is prone to vary depending upon the ambient temperature.

To cope with this problem, the present assignee has been disclosed in U.S. Pat. No. 6,439,359 an impact-type vibration damper, which attains vibration damping action on the basis of striking action of an independent mass member against a housing in association with resilient displacement of the independent mass member. The vibration damper includes: a housing fixed to the vibrating member; and an independent mass member which is disposed within the housing without being bonded to the housing so as to be displaceable or movable relative to the housing. In association with input of vibration, the independent mass member is brought into impact against the housing via an elastic abutting surface, whereby the vibration damper will exhibit damping effect utilizing energy loss through sliding friction or impact. By means of adjusting the mass of the independent mass member and the spring rigidity of an elastic material which constitutes the elastic abutting surface of the independent mass member against the housing, this proposed vibration damper is capable of exhibiting a high damping effect over a wide frequency range of input vibrations while assuring a relatively small mass of the independent mass member.

However, the proposed vibration damper also suffers from problems in tuning in order to exhibit an excellent damping effect with respect to a desired frequency vibration. That is, tuning of the vibration damper is limited by several conditions. For instance, modifying a size of the independent mass member is limited by a given space for installation in the housing, while adjusting the spring rigidity of the elastic material which constitutes the elastic abutting surface of the independent mass member against the housing is difficult due to deterioration of its durability or other reasons. In particular, when a vibration to be damped has a low frequency, there are needed a relatively large mass of the mass member and a relatively small spring rigidity of the elastic abutting surface, which is difficult to sufficiently ensure. In this case, the vibration damper is insufficient to stably achieve a desired vibration damping effect with respect to vibrations within a low frequency band.

To cope with this problem, the present assignee has been disclosed in JP-A-2002-155988 an improved impact-type vibration damper having a structure wherein a mass member having a cylindrical or annular shape is fitted externally onto a vibrating member; and an abutting surface of the mass member against the vibrating member in a radial direction is formed of an elastic material which undergoes shearing deformation in association with abutment and affixed to the mass member. With this arrangement, there is no need to provide a housing around the mass member, thereby improving the freedom in tuning of the mass member. In addition, it is possible to set the spring constant of the abutting surface smaller in comparison with the case where the elastic material is subjected to compressive deformation, thereby making it easy to tune the vibration damper to a lower frequency band.

However, the vibration damper disclosed in JP-A-2002-155988 still has some problems. When mounting the vibration damper on the vibrating member, the mass member of cylindrical or annular shape is needed to be fitted externally from an end of the vibrating member and moved along the longitudinal direction of the vibrating member, so that the mass member is placed at an intended position. This causes some trouble in mounting the vibration damper on the elongated vibrating member. Still worse, in the case where, for example, the vibrating member has a transverse cross section varying in the lengthwise direction, or in the case where there are bending portions or curved portions between the end of the vibrating member from which the mass member is fitted and the position where the mass member is installed, it is sometimes impossible to fit the mass member externally onto the vibrating member along the longitudinal direction depending on their shapes or sizes. Furthermore, the mass member of the proposed vibration damper is needed to be installed before the end of the vibrating member is secured to another member. This causes another problem that it is impossible to mount the vibration damper on the vibrating member whose end is already secured to another member and is closed off.

Originally, it is necessary for cylindrical vibration dampers including a mass member of cylindrical or annular shape to establish the shapes, sizes, constructions and other aspects of the mass member and the abutting surface corresponding to the aspects of areas of the vibrating member where the mass member is fitted externally in the longitudinal direction so as not to cause trouble in mounting on the vibrating member. Accordingly, tuning performance of the vibration damper is limited, whereby sufficient vibration damping action is difficult to achieve.

### SUMMARY OF THE INVENTION

It is therefore one object of this invention to provide a novel method of producing a cylindrical vibration-damping device that is able to readily mount an impact-type cylindrical vibration-damping device on a rod shaped vibrating member, and that is able to advantageously ensure desired damping effect. It is another object of the present invention to provide a cylindrical vibration-damping device of novel construction produced by the method of the present invention.

It is yet another object of this invention to provide a vibration-damping structure including a cylindrical vibration-damping device of novel construction wherein an impact-type cylindrical vibration-damping device is able to be readily mounted on a rod shaped vibrating member, and wherein an excellent desired damping effect is assured.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a method of producing an impact-type cylindrical vibration-damping device comprising the steps of: (I) preparing a main rubber elastic body of hollow cylindrical shape such that the main rubber elastic body includes a mass installation groove open in an outer circumferential surface thereof and extending in a circumferential direction thereof, and has a slit formed at one circumferential position while extending over an entire axial length thereof; (II) expanding the main rubber elastic body at the slit in order to mount the main rubber elastic body about a rod shaped vibrating member whose vibration to be damped through the slit from a radially outer side of the rod shaped vibrating member such that an entire inner circumferential surface of the main rubber elastic body is radially spaced away from an outer circumferential surface of the rod shaped vibrating member, and a radial distance between the inner circumferential surface of the main rubber elastic body and the outer circumferential surface of the rod shaped vibrating member is made smallest at a portion which is remote from the mass installation groove in an axial direction of the main rubber elastic body in order to form an abutting inner surface adapted to come into abutting contact against the rod shaped vibrating member, (III) preparing a mass member separately from the main rubber elastic body; and (IV) fixing the mass member to the main rubber elastic body by fitting the mass member onto the mass installation groove of the main rubber elastic body.

In the method of producing an impact-type cylindrical vibration-damping device according to the method of the present invention, the cylindrical vibration-damping device being mounted on the vibrating member is realized by means of mounting the main rubber elastic body around the vibrating member through the slit from the radially outer side of the vibrating member, and fixing the mass member to the main rubber elastic body by fitting the mass member onto the mass installation groove of the main rubber elastic body.

According to this method, it is possible to directly mount the vibration-damping device at the intended position on the vibrating member without fitting the vibration-damping device externally from an axial end of the vibrating member, permitting extremely readily installation of the vibration-damping device on the vibrating member. In addition, it is possible to modify the shapes or designs of the main rubber elastic body and the mass member without taking into consideration features including a shape or size of an area of the vibrating member other than the position where the vibration-damping device is to be mounted; a space for mounting the device; and a state of the vibrating member whether the end thereof is already secured to another member or not. This makes it possible to precisely establish the radial distance between the abutting inner surface of the main rubber elastic body and the outer circumferential surface of the vibrating member or the mass of the mass member with high accuracy, thereby advantageously improving tuning performance of the vibration-damping device.

Furthermore, since the mass member is separately prepared from the main rubber elastic body, various kinds of vibration-damping devices are readily realized by adopting a combination of a plurality of mass members having different sizes, masses, or other aspects and a plurality of main rubber elastic bodies having different spring rigidities or other aspects. That is, tuning performance of the vibration-damping device with respect to vibration frequency band to be damped is further improved.

Accordingly, the vibration-damping device is readily mounted on the vibrating member and advantageously exhibits desired damping effects.

Additionally, producing the vibration-damping device and mounting the vibration-damping device on the vibrating member are realized in a series of operations. This means that there is no need to keep any stock of a specific amount of the vibration-damping devices before mounting on the vibrating member, thereby extremely improving production efficiency.

A second mode of the invention provides a method of producing the impact-type cylindrical vibration-damping device according to the first mode, wherein the step of fixing the mass member comprises the step of fitting the mass member onto an outer circumferential surface of the mass installation groove with no adhesive therebetween. According to this method, adhesive processing steps of the mass member and the main rubber elastic body can be omitted, whereby ease of fabrication is more advantageously improved.

Especially in this mode, since the mass member is fitted onto the outer circumferential surface of the main rubber elastic body with no adhesive therebetween, constraining force of the mass member acting against the main rubber elastic body will be reduced. Accordingly, deformation of the main rubber elastic body is sufficiently ensured, thereby achieving excellent tuning performance of the vibration-damping device with respect to the low frequency band especially by means of its low spring rigidity.

Furthermore, owing to the mass member fitted onto the outer circumferential surface of the main rubber elastic body with no adhesive therebetween, the present vibration-damping device can expect vibration damping action based on sliding friction generated between the mass member and the main rubber elastic body during vibration input. This makes it possible to further advantageously broadening characteristics of the vibration-damping device of the present invention.

Accordingly, tuning performance of the vibration-damping device with respect to vibration frequency band to be damped is improved, thereby achieving excellent desired damping effect with respect to the above-mentioned vibrations within the low frequency band as well.

A third mode of the invention provides a method of producing the impact-type cylindrical vibration damping device according to the first or second mode, wherein the step of preparing the mass member comprises the step of preparing the mass member in a C-letter shape to have an opening in one circumferential position thereof; and wherein the step of fixing the mass member to the main rubber elastic body further comprising the steps of installing the mass member around the mass installation groove of the main rubber elastic body through the opening of the mass member, and executing a diameter reducing operation on the mass member installed around the main rubber elastic body in order to fix the mass member onto the mass installation groove of the main rubber elastic body. According to this mode, bending deformation of the mass member in the circumferential direction is readily permitted, making it easy to execute a diameter reducing operation on the mass member. In addition, the inner circumferential surface of the mass member is held in more close contact with the outer circumferential surface of the main rubber elastic body, making it possible to improve vibration damping action based on sliding friction generated between the mass member and the main rubber elastic body.

A fourth mode of the invention provides a method of producing the impact-type cylindrical vibration damping device according to the first or second mode, wherein the step of preparing the mass member comprising the step of preparing the mass member including a plurality of segmented bodies, and wherein the step of fixing the mass member to the main rubber elastic body further comprising the steps of fitting the plurality of segmented bodies of the mass member onto the mass installation groove so as to be fixedly connected to one another in the circumferential direction. According to this mode, it is possible to fit the mass member onto the main rubber elastic body without a diameter reducing operation, making it easy to fix a mass member having high rigidity or large mass, for example, to the main rubber elastic body. Accordingly, it is possible to further advantageously improve tuning performance of the vibration-damping device based on modifying the aspects of the mass member.

A fifth mode of the invention provides an impact-type cylindrical vibration-damping device comprising: a main rubber elastic body of hollow cylindrical shape adapted to be mounted around a rod shaped vibrating member such that an entire inner circumferential surface of the main rubber elastic body is radially spaced away from an outer circumferential surface of the rod shaped vibrating member, the main rubber elastic body including at least one mass installation groove open in an outer circumferential surface while extending in a circumferential direction thereof, and a slit formed at one circumferential position while extending over an entire axial length thereof; and at least one mass member formed as a separate element from the main rubber elastic body and fixed to the main rubber elastic body by being fitted onto the mass installation groove, wherein an abutting inner surface adapted to come into abutting contact against the rod shaped vibrating member during resilient displacement in an axis-perpendicular direction relative to the rod shaped vibrating member is formed at a position in the inner circumferential surface of the main rubber elastic body which is spaced away in an axial direction from the mass installation groove to which the mass member is fixed, and a radial distance between the abutting inner surface of the main rubber elastic body and the outer circumferential surface of the rod shaped vibrating member is made smaller than a radial distance between an inner surface of an area of the main rubber elastic body where the mass installation groove is formed and the outer circumferential surface of the rod shaped vibrating member.

According to the cylindrical vibration-damping device of construction according to this mode, when vibration is input, the mass member is displaced so as to strike against the vibrating member via the abutting inner surface of the main rubber elastic body. Accordingly, by utilizing resonance action of the main rubber elastic body, the mass member is allowed to come to impact on vibrating member with an amplitude magnification of not smaller than 1 with respect to the vibrating member, even when the low frequency vibrations are applied to the vibration-damping device. As a result, the mass member is efficiently displaced in a resilient fashion, whereby the present vibration-damping device will advantageously exhibit vibration damping action based on energy loss through sliding friction or impact of the mass member against the vibrating member.

In one preferred aspect of the vibration-damping device according to this mode, the main rubber elastic body has a slit formed at one circumferential position while extending over the entire axial length thereof. When the main rubber elastic body is mounted around the vibrating member, the main rubber elastic body is expanded at the slit in order to fix the main rubber elastic body to the vibrating member through the slit from the radially outer side of the vibrating member. Accordingly, the processes of fitting the vibration-damping device externally from the axial end of the vibrating member and moving the vibration-damping device to the intended position are omitted, making it easy to install the vibration-damping device on the vibrating member. In addition, it is also possible to mount the vibration-damping device on the vibrating member whose end is already secured to another member and is closed off, thereby advantageously expanding installation style.

A sixth mode of the invention provides an impact-type cylindrical vibration-damping device according to the fifth mode, wherein the mass member is fitted onto an outer circumferential surface of the mass installation groove with no adhesive therebetween.

A seventh mode of the invention provides an impact-type cylindrical vibration-damping device according to the fifth or sixth mode, wherein the mass member installed around the mass installation groove is subjected to a diameter reducing operation and thereby fixed onto the mass installation groove. According to this arrangement, a stable installation of the mass member onto the main rubber elastic body can be realized by a simple operation.

An eighth mode of the invention provides an impact-type cylindrical vibration-damping device according to the seventh mode, wherein the mass member has a C-letter shaped cross section in the axis-perpendicular direction with an opening formed in one circumferential position thereof.

A ninth mode of the invention provides an impact-type cylindrical vibration-damping device according to the fifth or sixth mode, wherein the mass member includes a plurality of segmented bodies fixedly connected to one another in the circumferential direction.

A tenth mode of the invention provides a vibration-damping structure including an impact-type cylindrical vibration-damping device comprising: a main rubber elastic body of hollow cylindrical shape including at least one mass installation groove open in an outer circumferential surface while extending in a circumferential direction thereof, and a slit formed at one circumferential position while extending over an entire axial length thereof, the main rubber elastic body being mounted around a rod shaped vibrating member such that an entire inner circumferential surface of the main rubber elastic body is radially spaced away from an outer circumferential surface of the rod shaped vibrating member; and at least one mass member formed as a separate element from the main rubber elastic body and fixed to the main rubber elastic body by being fitted onto the mass installation groove, wherein an abutting inner surface adapted to come into abutting contact against the rod shaped vibrating member during resilient displacement in an axis-perpendicular direction relative to the rod shaped vibrating member is formed at a position in the inner circumferential surface of the main rubber elastic body which is remote in an axial direction from the mass installation groove to which the mass member is fixed, and a radial distance between the abutting inner surface of the main rubber elastic body and the outer circumferential surface of the rod shaped vibrating member is made smaller than a radial distance between an inner surface of an area of the main rubber elastic body where the mass installation groove is formed and the outer circumferential surface of the rod shaped vibrating member.

According to the vibration-damping structure of construction according to this mode, in the vibration-damping device which constitutes a secondary vibration system with respect to a primary vibration system, i.e., the vibrating member, the main rubber elastic body includes the mass installation groove open in the outer circumferential surface while extending in the circumferential direction thereof, and the slit formed at one circumferential position while extending over the entire axial length thereof. With this arrangement, in one preferred aspect of the vibration-damping structure according to this mode, when the main rubber elastic body is mounted around the vibrating member, the main rubber elastic body is opened at the slit in order to fix the main rubber elastic body to the vibrating member through the slit from the radially outer side of the vibrating member, while the mass member is fitted onto the mass installation groove.

Accordingly, the processes of fitting the vibration-damping device externally from the axial end of the vibrating member and moving the vibration-damping device to the intended position are omitted, making it easy to install the vibration-damping device on the vibrating member. In addition, it is also possible to mount the vibration-damping device on the vibrating member whose end is already secured to another member and is closed off, thereby advantageously expanding installation style. In addition, there is no special need to take into consideration features including a shape or size of an area of the vibrating member other than the position where the vibration-damping device is to be mounted; a space for mounting the device; and a state of the vibrating member whether the end thereof is already secured to another member or not. This makes it possible to precisely establish the radial distance between the abutting inner surface of the main rubber elastic body and the outer circumferential surface of the vibrating member with high accuracy, thereby advantageously improving tuning performance of the vibration-damping device.

Accordingly, the vibration-damping structure including the impact-type cylindrical vibration-damping device mounted on the rod shaped vibrating member is readily realized, and the desired vibration damping action is stably assured as well.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a cross sectional view of a vibration-damping structure including a cylindrical vibration-damping device of construction according to a first embodiment of the invention which is mounted around an arm whose vibration to be damped;

FIG. 2 is a cross sectional view taken along line 2-2 of FIG. 1;

FIG. 3 is a perspective view of a main rubber elastic body which constitutes a part of the vibration-damping device of FIG. 1;

FIG. 4 is a perspective view of a mass member which constitutes another part of the vibration-damping device of FIG. 1;

FIG. 5 is a vertical cross sectional view for explaining one manufacturing step of the vibration-damping device of FIG. 1;

FIG. 6 is a vertical cross sectional view for explaining one manufacturing step of the vibration-damping device of FIG. 1 different from the step shown in FIG. 5;

FIG. 7 is a vertical cross sectional view of a vibration-damping structure including a cylindrical vibration-damping device of construction according to a second embodiment of the invention which is mounted around the arm;

FIG. 8 is a vertical cross sectional view of a vibration-damping structure including a cylindrical vibration-damping device of construction according to a third embodiment of the invention which is mounted around the arm;

FIG. 9 is a vertical cross sectional view of a vibration-damping structure including a cylindrical vibration-damping device of construction according to a fourth embodiment of the invention which is mounted around the arm;

FIG. 10 is a vertical cross sectional view of a vibration-damping structure including a cylindrical vibration-damping device of construction according to a fifth embodiment of the invention which is mounted around the arm;

FIG. 11 is a vertical cross sectional view of a vibration-damping structure including a cylindrical vibration-damping device of construction according to a sixth embodiment of the invention which is mounted around the arm; and

FIG. 12 is a vertical cross sectional view of a vibration-damping structure including a cylindrical vibration-damping device of construction according to a seventh embodiment of the invention which is mounted around the arm.

### DETAILED DESCRIPTION OF PREFERRED EMBODIMENTS

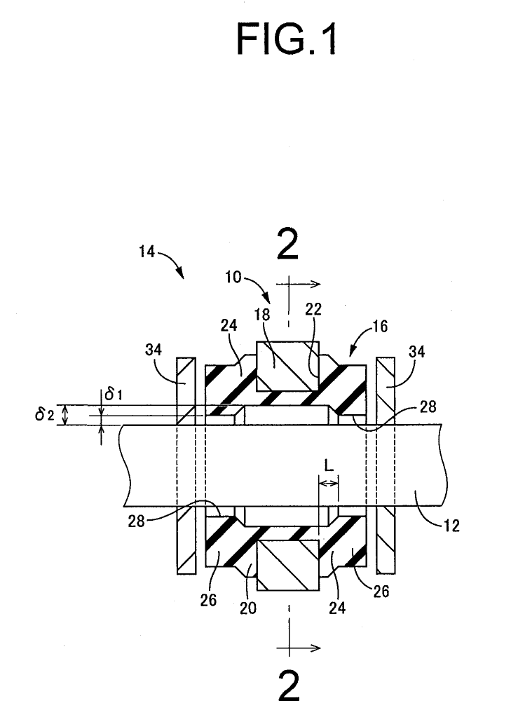

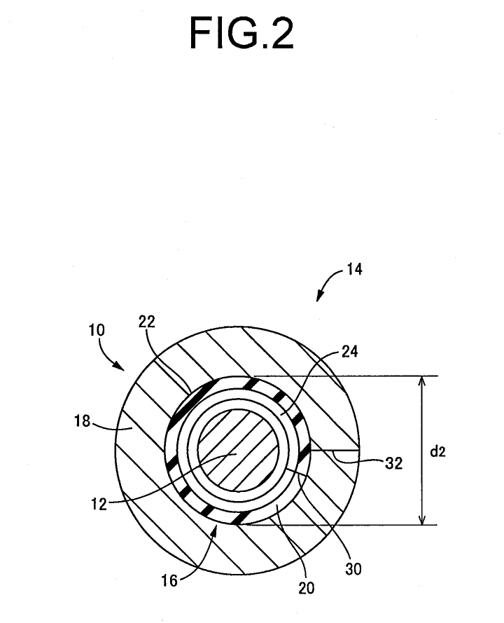

Referring first to FIGS. 1 and 2, shown is a vibration-damping structure 14 including a cylindrical vibration-damping device 10 constructed according to a first embodiment of the invention which is mounted around an arm 12 serving as a rod shaped vibrating member. The vibration-damping device 10 including a main rubber elastic body 16 and a mass member 18 is mounted around the arm 12, namely, a primary vibration system, so as to constitute a secondary vibration system with respect to the primary vibration system.

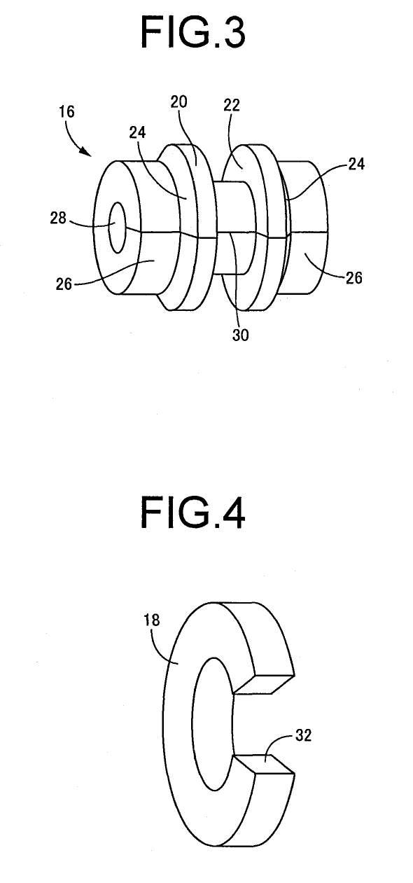

Described in detail, as shown in FIG. 3, the main rubber elastic body 16 is of generally cylindrical shape and formed of a rubber elastic material. The rubber elastic material may preferably have a Shore D hardness of 80 or lower, more preferably, within a range of 20-40, as measured in accordance with ASTM method D-2240, and may be preferably selected from a simple substance of natural rubber, styrene-butadiene rubber, isoprene rubber, acrylonitrile-butadiene rubber, chloroprene rubber, butyl rubber, or a composite material thereof, for example.

The main rubber elastic body 16 has a mass installation groove 22 formed on a cylindrical center portion 20 located at a center portion of the main rubber elastic body 16 in an axial direction (sideways in FIG. 1). The mass installation groove 22 has a rectangular recessed cross section opening in an outer circumferential face of the cylindrical center portion 20 and extending continuously about an entire circumference of the main rubber elastic body 16. The mass installation groove 22 has a widthwise dimension slightly smaller than an axial length of the cylindrical center portion 20 and of one-fourth to one-half of an axial length of the main rubber elastic body 16 as a whole. The mass installation groove 22 as described above is formed on the cylindrical center portion 20, whereby the main rubber elastic body 16 has its thickness dimension made small at an axial center portion thereof, which constitutes a bottom portion of the mass installation groove 22.

The cylindrical center portion 20 of the main rubber elastic body 16 has tapered portions 24 at axially opposite ends thereof. Each of the tapered portion 24 has a diameter dimension which becomes gradually smaller going axially outward. Further, each small-diameter end portion of the each tapered portion 24 has a cylindrical end portion 26 extending in the axial direction. A thickness dimension of axially either side of the cylindrical center portion 20, at which no mass installation groove 22 is formed, is approximately the same as a thickness dimension of the each cylindrical end portion 26.

In other words, as shown in FIG. 3, an outside diameter dimension of the main rubber elastic body 16 is made larger at the cylindrical center portion 20 having the mass installation groove 22 rather than each of the cylindrical end portion 26 on axially either side of the cylindrical center portion 20. That is, the outside diameter dimension of the cylindrical center portion 20 represents the maximum outside diameter dimension of the main rubber elastic body 16. With this arrangement, each of the cylindrical end portion 26, namely, an axially either end portion of the main rubber elastic body 16, has a shape whose inner circumferential surface projects out radially inward from an inner circumferential surface of the cylindrical center portion 20 of the main rubber elastic body 16. With respect to an inner circumferential surface of the main rubber elastic body 16, the inner circumferential surface of each of the cylindrical end portions 26 projecting out radially inward from the inner circumferential surface of the cylindrical center portion 20 serves as an abutting inner surface 28 according to this embodiment. Each of the abutting inner surfaces 28 has a round tubular shape extending continuously in a circumferential direction. As will be apparent from the above description, as shown in FIG. 1, the abutting inner surface 28 according to this embodiment is formed on axially either side of the mass installation groove 22. The each abutting inner surface 28 is positioned axially spaced away from each widthwise end portion of the mass installation groove 22 by a prescribed distance: L.

The main rubber elastic body 16 has a slit 30 formed at one circumferential position thereof. The slit 30 penetrates the inner and outer circumferential surface of the main rubber elastic body 16 in the thickness direction, while extending over an entire axial length of the main rubber elastic body 16 so as to penetrate an axial end face of the each cylindrical end portion 26. With this arrangement, the main rubber elastic body 16 has a cylindrical shape which is slit at one circumferential position in the axial direction.

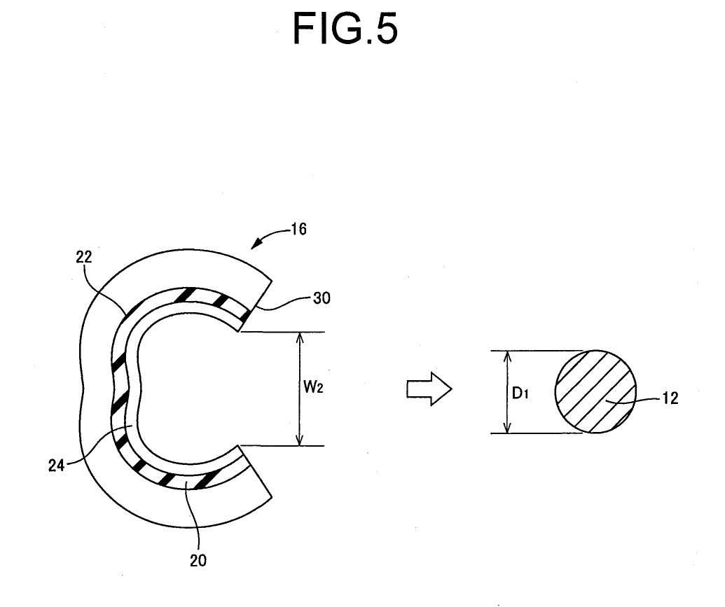

The slit 30 is formed, for example, by means of the main rubber elastic body 16 being subjected to a cut operation along a line extending in the axial direction at one circumferential position after vulcanization molding. In the state that the main rubber elastic body 16 is not deformed, the main rubber elastic body 16 has its opposite end faces, divided by the slit 30 in the vertical direction in FIG. 5, either superposed against each other over the entire length thereof or opposed to each other with a small gap therebetween in the circumferential direction of the main rubber elastic body 16 so that the slit 30 appears to be of generally linear shape.

Meanwhile, as shown in FIG. 4, the mass member 18 is of C-letter shape extending with a rectangular cross section substantially unchanging in a circumferential direction. The mass member 18 is made of a metallic material such as iron or aluminum, a resin material such as nylon resin, or a composite material thereof.

The mass member 18 has an opening 32 in one circumferential position thereof. The opening 32 penetrates the inner and outer circumferential surface of the mass member 18 in the thickness direction, while extending in an axial direction with a prescribed opening dimension so as to penetrate axially opposite end faces of the mass member 18. With this arrangement, the mass member 18 has the C-letter shaped cross section in an axis-perpendicular direction.

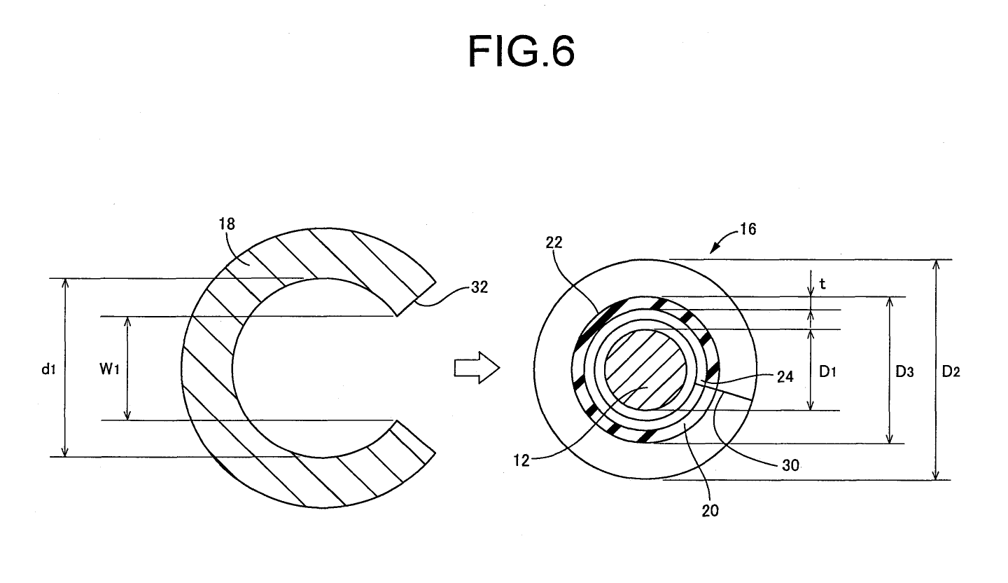

In this embodiment in particular, the main rubber elastic body 16 and the mass member 18 is molded so that the following Equation 1 is met, where “W1” is the spacing between the opposite end portions of the mass member 18 divided by the opening 32 (spacing in the vertical direction in FIG. 6), namely, the minimum opening dimension of the opening 32, “D1” is the diametrical dimension of the arm 12, and “t1” is the thickness dimension of the cylindrical center portion 20 of the main rubber elastic body 16 where the bottom portion of the mass installation groove 22 is formed (see FIG. 6).

W1≧D1+2t Equation 1

That is, the opening 32 has the minimum opening dimension: W1 that is made identical with or larger than the sum of the diametrical dimension: D1 of the arm 12 and the radial dimension of the cylindrical center portion 20 of the main rubber elastic body 16 where the bottom portion of the mass installation groove 22 is formed (2 times the thickness dimension: t).

In this embodiment, the minimum opening dimension: W1 of the opening 32 is made larger than the diametrical dimension: D1 of the arm 12, and furthermore, is made slightly larger than the sum of the diametrical dimension: D1 of the arm 12 and the radial dimension of the cylindrical center portion 20 where the bottom portion of the mass installation groove 22 is formed, namely, D1+2 t. Additionally, the minimum opening dimension: W1 of the opening 32 is made smaller than the outside diameter dimension: D2 of the cylindrical center portion 20 of the main rubber elastic body 16 (the maximum outside diameter dimension of the main rubber elastic body 16), and furthermore, is made slightly smaller than the outside diameter dimension: D3 of the mass installation groove 22 prior to fixing the mass member 18 to the mass installation groove 22 of the main rubber elastic body 16.

The inside diameter dimension: d1 of the mass member 18 which is orthogonal to a direction in which the opening 32 of the mass member 18 opens prior to being fixed to the mass installation groove 22 (sideways in FIG. 6) is made smaller than the outside diameter dimension: D2 of the cylindrical center portion 20 of the main rubber elastic body 16, while being made larger than the outside diameter dimension: D3 of the mass installation groove 22 prior to fixing of the mass member 18.

The mass member 18 installed around the mass installation groove 22 of the main rubber elastic body 16 is subjected to a diameter reducing operation such as all directional drawing. In association with the diameter reducing deformation of the mass member 18, the opposite end portions of the mass member 18 divided by the opening 32 are displaced so as to approach each other, and moreover, superposed against each other in this embodiment.

Also, the diameter reducing operation of the mass member 18 makes the inside diameter dimension of the mass member 18 become smaller, namely, from d1 to d2 (see FIG. 2). The inside diameter dimension: d2 of the mass member 18 installed around the mass installation groove 22 is made slightly smaller than the outside diameter dimension: D3 of the mass installation groove 22 prior to fixing of the mass member 18. With this arrangement, an area where the mass installation groove 22 of the main rubber elastic body 16 is formed undergoes elastic deformation so that an entire inner circumferential surface of the mass member 18 is elastically held close contact with the outer circumferential surface of the cylindrical center portion 20 of the main rubber elastic body 16 where a bottom surface of the mass installation groove 22 is formed.

In addition, the mass member 18 has a dimension in the axial direction (sideways in FIG. 1) identical with or slightly larger than a dimension of the mass installation groove 22 in the widthwise direction (sideways in FIG. 1). With this arrangement, in the state that the mass member 18 is installed around the mass installation groove 22, the area where the mass installation groove 22 of the main rubber elastic body 16 is formed undergoes elastic deformation so that the axially opposite end faces of the mass member 18 is elastically held close contact with the outer circumferential surface of the cylindrical center portion 20 of the main rubber elastic body 16 where widthwise opposite surfaces of the mass installation groove 22 (in other words, opposite walls in the axial direction of the vibration-damping device 10) is formed.

Accordingly, the mass member 18 is fixed to the mass installation groove 22 so as to be fitted onto the outer circumferential surface of the main rubber elastic body 16 with no adhesive therebetween, whereby the vibration-damping device 10 according to the present embodiment is constructed.

The vibration-damping device 10 constructed as described above is mounted on the arm 12 as shown in FIGS. 1 and 2, whereby the vibration-damping structure 14 including the vibration-damping device 10 and the arm 12 is constructed. The arm 12 has a solid rod shape extending a prescribed length in the axial direction with a circular cross section and is employed as a suspension member of an automotive vehicle, for example.

The main rubber elastic body 16 of the vibration-damping device 10 is mounted around the arm 12 and disposed at a position which suffers from vibration excited in the arm 12. On axially either side of the vibration-damping device 10, an annular-shaped stopper members 34 serving as a positioning means is affixed to the arm 12. Since there is a distance between a pair of the stopper members 34, 34 in a longitudinal direction (sideways in FIG. 1) larger than an axial length of the vibration-damping device 10, displacement of the vibration-damping device 10 in the axial direction is allowed, while displacement of the vibration-damping device 10 beyond the pair of the stopper members 34, 34 is limited.

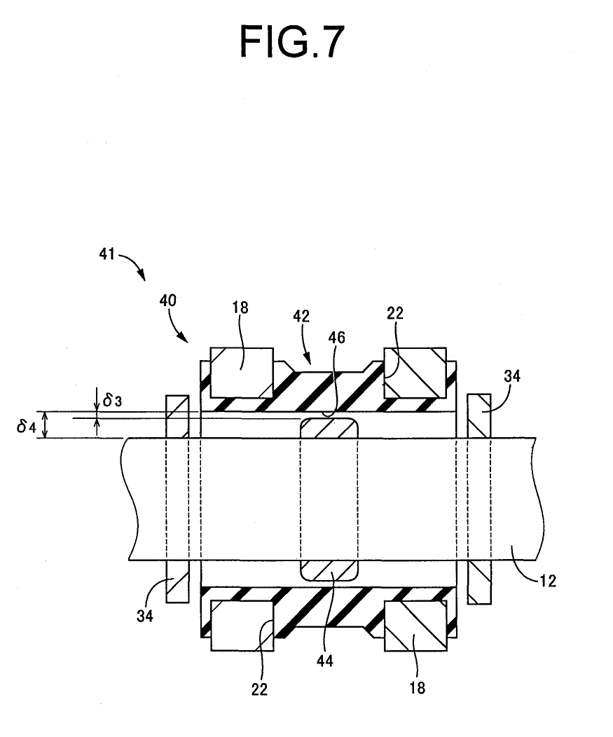

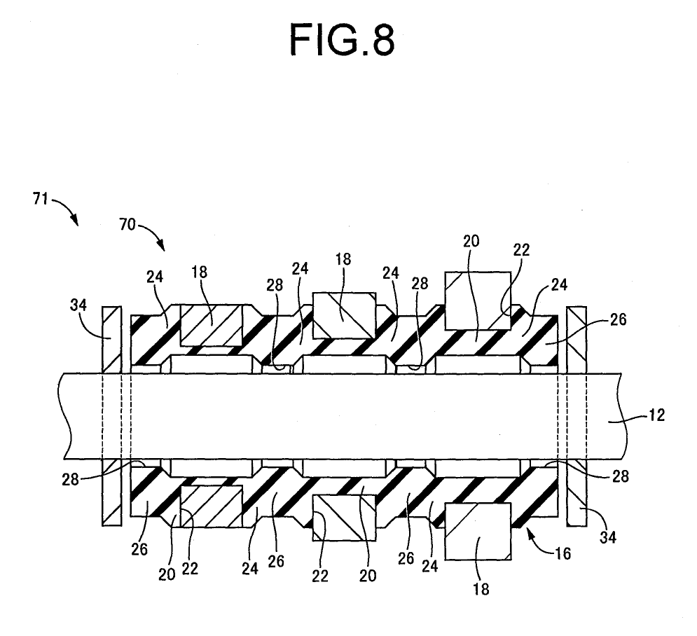

As the construction of the stopper members 34, it is possible to employ any of those known in the art, and a detailed description will not be provided here. Preferably, the construction that is able to be attached to the arm 12 from a radially outer side of the arm 12 is employed. For example, the stopper member 34 constructed as disclosed in FIG. 7 of JP-A-11-141600, which has a hinge portion formed at one circumferential position thereof and can circumferentially be opened, is employable. In this case, the stopper member 34 is opened and attached to the arm 12 from the radially outer side of the arm 12, and then the opened portion of the stopper member 34 is closed while being secured to the arm 12 at the same time. Alternatively, the stopper member 34 constructed as disclosed in FIG. 8 of JP-A-11-141600, which includes a plurality of circumferentially segmented bodies, is employable. In this case, these segmented bodies are disposed so as to surround the arm 12, and then affixed to one another while being secured to the arm 12 by bolts or the like. Alternatively, the stopper member 34 may be integrally affixed to the arm 12 in advance.

As shown in FIG. 1, with the vibration-damping device 10 and the arm 12 being placed in a concentric fashion, there is provided a radial space of given dimension: δ1 between the abutting inner surface 28 of the main rubber elastic body 16 and an outer circumferential surface of the arm 12 continuously over an entire circumference thereof, while there is provided a radial space of given dimension: δ2 between the inner circumferential surface of the cylindrical center portion 20 of the main rubber elastic body 16 and the outer circumferential surface of the arm 12 continuously over an entire circumference thereof. The dimensions δ1 and δ2 are arranged to meet the condition “δ1<δ2”. In short, the main rubber elastic body 16 is mounted around the rod shaped arm 12 with a radial space over the entire circumference thereof. In FIGS. 1 and 2, for the sake of simply understanding of the present invention, there is shown the vibration-damping device 10 and the arm 12 being placed in a concentric fashion. However, in a static state in which the vibration-damping device 10 is mounted around the arm 12 and no vibrational load is applied thereto, the vibration-damping device 10 is displaced downwardly by a distance: δ1 in the vertical direction due to the gravity acting, whereby one circumferential portion of each of the abutting inner surface 28 of the main rubber elastic body 16 is held in contact with the outer circumferential surface of the arm 12.

Next, there will be described in combination one example of a producing method of the vibration-damping device 10 and one example of a producing method of the vibration-damping structure 14 including the vibration-damping device 10 and the arm 12 according to this embodiment. It should be noted that the each producing method is not limited to the illustrated one.

Initially, the main rubber elastic body 16, the mass member 18, the pair of the stopper members 34, 34 are prepared as separate elements from each other. This completes the steps of: preparing the main rubber elastic body 16 including the mass installation groove 22 and the slit 30; and preparing the mass member 18 as a separate element from the main rubber elastic body 16.

Then, as shown in FIG. 5, a spacing between the opposite end faces of the main rubber elastic body 16 divided by the slit 30 (spacing in the vertical direction in FIG. 5), namely, the minimum opening dimension: W2 of the slit 30, is made larger than the diametrical dimension: D1 of the arm 12. This makes the slit 30 open in the circumferential direction on the basis of elastic deformation of the main rubber elastic body 16.

Subsequently, an intended portion of the arm 12 is inserted into an inside of the main rubber elastic body 16 through the opened slit 30. In other words, the main rubber elastic body 16 is mounted around the arm 12 through the opened slit 30 from the radially outer side thereof (sideways in FIG. 5, for example). Then, the main rubber elastic body 16 is released from the elastic deformation to become an original state in which the slit 30 is closed, thereby recovering its initial cylindrical shape.

As a result, the entire inner circumferential surface of the main rubber elastic body 16 is radially spaced away from the outer circumferential surface of the arm 12. Here, the abutting inner surfaces 28, 28 formed at axially opposite sides of the inner circumferential surface of the cylindrical center portion 20 where the mass installation groove 22 is formed have the smallest radial distance with respect to the outer circumferential surface of the arm 12, in comparison with the other parts of the inner circumferential surface of the main rubber elastic body 16. This completes the step of mounting the main rubber elastic body 16 around the arm 12.

Next, as shown in FIG. 6, the mass member 18 is installed around the mass installation groove 22 of the main rubber elastic body 16 mounted on the arm 12 from the radially outer side thereof, and a portion of the cylindrical center portion 20 of the main rubber elastic body 16, having the arm 12 fitted within, which constitutes the bottom portion of the mass installation groove 22 (an axially center portion of the main rubber elastic body 16) is inserted into an inside of the mass member 18 through the opening 32.

In this embodiment in particular, the minimum opening dimension: W1 of the opening 32 is made slightly smaller than the outside diameter dimension: D3 of the mass installation groove 22 prior to fixing of the mass member 18, while being made larger than the sum of the diametrical dimension: D1 of the arm 12 and the radial dimension of the cylindrical center portion 20 of the main rubber elastic body 16 where the bottom portion of the mass installation groove 22 is formed (2 times the thickness dimension: t). Also, the outer circumferential surface of the arm 12 is radially spaced away from the inner circumferential surface of the cylindrical center portion 20 by a distance: δ2. Accordingly, it is possible to insert the cylindrical center portion 20 having the arm 12 fitted within into the inside of the mass member 18 through the opening 32 with the cylindrical center portion 20 elastically deformed so as to reduce its diameter.

The mass member 18 installed around the mass installation groove 22 of the main rubber elastic body 16, while having the cylindrical center portion 20 which is mounted around the arm 12 fitted within, is subjected to a diameter reducing operation such as all directional drawing from the radially outer side thereof. Subsequently, in association with the diameter reducing deformation of the mass member 18, the opposite end portions of the mass member 18 divided by the opening 32 are displaced so as to approach each other and then superposed against each other so as to be butted together. This diameter reducing operation on the mass member 18 makes the entire inner circumferential surface of the mass member 18 elastically held close contact with the outer circumferential surface of the cylindrical center portion 20 of the main rubber elastic body 16 where the bottom surface of the mass installation groove 22 is formed. Additionally, this arrangement makes the axially opposite end faces of the mass member 18 elastically held close contact with the outer circumferential surface of the cylindrical center portion 20 of the main rubber elastic body 16 where the widthwise opposite surfaces of the mass installation groove 22 is formed. This completes the step of fixing the mass member 18 to the main rubber elastic body 16 by means of fitting the mass member 18 onto the mass installation groove 22 of the main rubber elastic body 16 mounted around the arm 12, thereby realizing the vibration-damping device 10 with the arm 12 fitted within the main rubber elastic body 16. In this embodiment in particular, the mass member 18 is fitted onto the outer circumferential surface of the main rubber elastic body 16 with no adhesive therebetween.

Furthermore, for example, the stopper member 34 which has a hinge portion formed at one circumferential position thereof and can circumferentially be opened in the circumferential direction is attached to the arm 12 from the radially outer side thereof, and then the opened portion thereof (not shown) is circumferentially closed while being secured to the arm 12 at the same time. While securing the pair of the stopper members 34, 34 to the arm 12, these stopper members 34, 34 are opposed being spaced apart from each other by a distance larger than the axial length of the vibration-damping device 10. Then, the vibration-damping device 10 mounted on the arm 12 is positioned between the opposed faces of the stopper members 34, 34. Here, the stopper members 34 may be secured to the arm 12 either before or after mounting the vibration-damping device 10 on the arm 12. Alternatively, for example, it is possible to press the stopper members 34 of circumferentially continuous annular shape fitted onto the arm 12 from its end portion and secured thereto, and then mount the vibration-damping device 10 on the arm 12 extending between the opposed faces of the pair of the stopper members 34, 34 in the way as described above. Specifically, the construction of the stopper member 34 or the way in the step of fixing the vibration-damping device 10 and the stopper member 34 to the arm 12 are established depending on a shape of the arm 12, a mode of placement on an automotive vehicle, or a manufacturing efficiency. With this arrangement, the vibration-damping structure 14 as shown in FIGS. 1 and 2 which includes the vibration-damping device 10 mounted on the arm 12 is realized.

In the vibration-damping device 10 constructed as described above, upon input of vibration to the arm 12 in the axis-perpendicular direction, the main rubber elastic body 16 and the arm 12 undergo relative displacement in the axis-perpendicular direction. At this time, the abutting inner surfaces 28 each having the radial distance with respect to outer circumferential surface of the arm 12 smaller than that of the inner circumferential surface of the cylindrical center portion 20 of the main rubber elastic body 16 come into abutting contact against the outer circumferential surface of the arm 12. In other words, the mass member 18 comes into abutting contact against the arm 12 via the abutting inner surfaces 28 of the main rubber elastic body 16, whereby the vibration-damping device 10 exhibits vibration damping action based on energy loss through sliding friction or impact during the abutting contact of the mass member 18 against the arm 12.

In this embodiment in particular, as shown in FIG. 1, each of the abutting inner surfaces 28 is axially apart by a prescribed distance: L from the mass installation groove 22 formed in the cylindrical center portion 20 of the main rubber elastic body 16. In addition, each of the abutting inner surfaces 28 has the radial distance with respect to the outer circumferential surface of the arm 12 smaller than that of the inner circumferential surface of the cylindrical center portion 20. With this arrangement, when the mass member 18 comes into abutting contact against the arm 12 via the abutting inner surfaces 28, the external load in the shearing direction is exerted between the cylindrical end portions 26 including the abutting inner surfaces 28 and the mass member 18, whereby the tapered portions 24, 24 of the main rubber elastic body 16 provided between the cylindrical center portion 20 and each of the cylindrical end portions 26 undergo mainly shearing deformation.

As a result, the vibration-damping device 10 is able to achieve low spring properties based on the shearing deformation of the tapered portions 24, making it easy to tune a resonance frequency or the peak of the damping effect based on the impacts of the mass member 18 on the arm 12 to a low frequency band. Therefore, the vibration-damping device 10 can advantageously exhibit desired damping effects with respect to the vibrations within the low frequency band.

Meanwhile, one preferred producing method of the vibration-damping device 10 according to this embodiment includes the steps of: preparing the main rubber elastic body 16 having the slit 30 formed at one circumferential position thereof, and the mass installation groove 22 open in the outer circumferential surface and extending in the circumferential direction of the main rubber elastic body 16; mounting the main rubber elastic body 16 around the arm 12 through the slit 30 from the radially outer side of the arm 12; and fixing the mass member 18 to the main rubber elastic body 16 by fitting the mass member 18 onto the mass installation groove 22.

According to this method, it is possible to directly mount the vibration-damping device 10 without fitting the vibration-damping device 10 externally from an axial end of the arm 12 and moving the vibration-damping device 10 to an intended position on the arm 12, whereby installation of the vibration-damping device 10 becomes extremely easy.

In this embodiment in particular, since the slit 30 formed at one circumferential position of the main rubber elastic body 16 appears to be of generally linear shape extending parallel to the axial direction of the main rubber elastic body 16, it can be easy to mold the slit 30. Also, opening process of the slit 30 is easy as well. In addition, when the main rubber elastic body 16 is mounted on the arm 12, its opposite end portions divided by the slit 30 is superposed against each other so that the slit 30 is closed. Accordingly, undesirable effect of the slit 30 against spring properties is minimized, thereby stably achieving a desired vibration damping effect.

Furthermore, it is possible to modify the aspects of the main rubber elastic body 16 and the mass member 18 without taking into consideration aspects of the arm 12: a shape, size of the areas other than the position where the vibration-damping device 10 is to be mounted; whether there is enough space for mounting or not; and whether the end of the arm 12 is already secured to another member which constitutes the automotive vehicle or not. As a result, it is possible to establish the radial distance between each of the abutting inner surfaces 28 of the main rubber elastic body 16 and the outer circumferential surface of the arm 12 or the mass of the mass member 18 with high accuracy, thereby advantageously improving tuning performance of the vibration-damping device 10.

Still further, since the mass member 18 and the main rubber elastic body 16 are separately prepared from each other, it is possible to exchange at least one of the existent mass member 18 and the main rubber elastic body 16 with those having modified configuration depending on the vibration frequency band to be damped. For example, the mass member 18 having its size or mass modified, or the main rubber elastic body 16 having its spring rigidity or other aspects modified is adoptable.

That is, when molding the mass member 18 and the main rubber elastic body 16, an independent mold for each is prepared. Thus, the construction of the mold is simpler compared with that of the mold for the mass member 18 and the main rubber elastic body 16 integrally vulcanization molded with each other.

It should be noted that when tuning the vibration-damping device 10 with respect to the certain vibration frequency band, if the mass member 18 and the main rubber elastic body 16 are integrally vulcanization molded with each other, the vibration-damping device 10 needs another mold with different aspects anew in order to modify configuration of at least one of the mass member 18 and the main rubber elastic body 16. On the other hand, the vibration-damping device 10 according to this embodiment only needs to modify the mold of either the mass member 18 or the main rubber elastic body 16, thereby making tuning easier. In addition, by adopting a combination of a plurality of mass members 18 and a plurality of main rubber elastic bodies 16 having different aspects, tuning properties of the vibration-damping device 10 are advantageously improved with a simple construction.

Furthermore, in the case the mass member 18 and the main rubber elastic body 16 are integrally vulcanization molded with each other, it should take relatively long time for vulcanization. Otherwise, crosslinking condition of the main rubber elastic body 16 may be unstable due to effect of heat capacity of the mass member 18 or the like. With this respect, in the present embodiment, since the mass member 18 and the main rubber elastic body 16 are separately prepared from each other, there is no need to consider the effect of the heat capacity of the mass member 18 or the like. Accordingly, it takes shorter time to mold the main rubber elastic body 16 compared with the case where the mass member 18 and the main rubber elastic body 16 are integrally vulcanization molded with each other, thereby exhibiting a high productivity.

Still further, the mass installation groove 22 is formed opening in the outer circumferential surface of the main rubber elastic body 16 onto which the mass member 18 is fitted so as to be fixed to the outer circumferential surface of the main rubber elastic body 16, whereby a stable installation of the mass member 18 onto the main rubber elastic body 16 can be realized. This omits the complicated process in fixing the mass member 18 to the main rubber elastic body 16 such as applying an adhesive between the mass member 18 and the main rubber elastic body 16, forming an integrally vulcanization molded component of the mass member 18 and the main rubber elastic body 16, or the like. Consequently, ease of fabrication is advantageously improved.

In this embodiment in particular, the mass member 18 is fixed onto the outer circumferential surface of the main rubber elastic body 16 with no adhesive therebetween. With this arrangement, fabrication is more advantageously improved, as well as minimizing constraining force of the mass member 18 against the main rubber elastic body 16. Accordingly, deformation of the main rubber elastic body 16 is sufficiently ensured, thereby achieving excellent tuning performance of the vibration-damping device 10 with respect to the low frequency band especially by means of its low spring rigidity.

Besides, the bottom surface of the mass installation groove 22 is elastically held close contact with the inner circumferential surface of the mass member 18, while the axially opposite walls of the mass installation groove 22 is elastically held close contact with the axially opposite end faces of the mass member 18. Accordingly, the sliding friction is advantageously generated between the mass member 18 and the main rubber elastic body 16 during vibration input. This makes it possible to advantageously broadening damping characteristics of the vibration-damping device 10 of the present invention.

Accordingly, tuning performance of the vibration-damping device 10 with respect to vibration frequency band to be damped is improved, thereby achieving excellent desired damping effect with respect to the above-mentioned vibrations within the low frequency band as well. The vibration-damping device 10 with aforementioned advantages is readily mounted on the arm 12, thereby realizing the vibration-damping structure 14 including the vibration-damping device 10 and the arm 12.

In this embodiment, whereas the minimum opening dimension: W1 of the opening 32 of the mass member 18 is slightly made smaller than the outside diameter dimension: D3 of the mass installation groove 22 prior to fixing the mass member 18, the dimension: W1 is made larger than the diametrical dimension: D1 of the arm 12, and the outer circumferential surface of the arm 12 is radially spaced away from the inner circumferential surface of the cylindrical center portion 20 by a distance: δ2. As a result, it is possible to insert the cylindrical center portion 20 having the arm 12 fitted within into the inside of the mass member 18 through the opening 32 with the cylindrical center portion 20 elastically deformed so as to reduce its diameter. Accordingly, an installation style of mounting the vibration-damping device 10 on the arm 12 and producing the vibration-damping device 10 in parallel can be advantageously realized.

It should be noted that the minimum opening dimension: W1 of the opening 32 of the mass member 18 is made slightly larger than the sum of the diametrical dimension: D1 of the arm 12 and the radial dimension of the cylindrical center portion 20 where the bottom portion of the mass installation groove 22 is formed, namely, D1+2 t. This arrangement prevents corners or edges of the opening 32 of the mass member 18 from coming into contact with and damaging the cylindrical center portion 20 during inserting the cylindrical center portion 20 into the inside of the mass member 18 through the opening 32, thereby improving durability of the main rubber elastic body 16.

Besides, the inside diameter dimension: d1 of the mass member 18 prior to being fitted onto the mass installation groove 22 is made smaller than the outside diameter dimension: D2 of the cylindrical center portion 20 of the main rubber elastic body 16, while being made larger than the outside diameter dimension: D3 of the mass installation groove 22 prior to fitting of the mass member 18. This arrangement ensures ease of fitting the mass member 18 onto the mass installation groove 22, while minimizing the inside diameter dimension: d1 of the mass member 18. Consequently, a diameter reducing operation on the mass member 18 is readily executed, whereby fixing the mass member 18 to the mass installation groove 22 becomes still easier.

Referring next to FIG. 7, there is shown a vibration-damping structure 41 including a cylindrical vibration-damping device 40 constructed according to a second embodiment of the invention which is mounted around the arm 12. The vibration-damping device 40 according to the present embodiment includes elements which are different from the main rubber elastic body 16 or the abutting inner surfaces 28 of the vibration-damping device 10 according to the first embodiment of the invention. In the following explanation, the same reference numerals as used in the illustrated embodiment are used for identifying structurally and functionally corresponding elements, to facilitate understanding of the instant embodiment.

A main rubber elastic body 42 according to this embodiment is of cylindrical shape extending straightly, and has an inside diameter dimension substantially unchanging throughout. The main rubber elastic body 42 has a pair of mass installation grooves 22, 22 opening in its outer circumferential surface, each provided on either side of its axially central portion and positioned axially outward therefrom. The mass member 18 is fitted onto the each mass installation groove 22 and fixed to an outer circumferential surface of the main rubber elastic body 42 with no adhesive therebetween.

The main rubber elastic body 42 has the slit 30 formed at one circumferential position which is structurally identical with the slit 30 in the vibration-damping device 10 of the first embodiment. By opening the slit 30 and inserting the arm 12 into an inside of the main rubber elastic body 42 through the opened slit 30, the main rubber elastic body 42 is mounted around the arm 12 with its entire inner circumferential surface radially spaced away from the outer circumferential surface of the arm 12.

The arm 12 has an abutting ring 44 secured onto an area which is radially opposed to the axially central portion of the main rubber elastic body 42 by pressing or the like. The abutting ring 44 is of generally annular shape extending with a rectangular cross section substantially unchanging all the way around in a circumferential direction.

As shown in FIG. 7, with the vibration-damping device 40 and the arm 12 being placed in a concentric fashion, there is provided a radial space of given dimension: δ3 between an inner circumferential surface of the axially central portion of the main rubber elastic body 42 (an inner circumferential surface between the pair of mass installation grooves 22, 22) and an outer circumferential surface of the abutting ring 44 secured to the arm 12 continuously over an entire circumference thereof, while there is provided a radial space of given dimension: δ4 between inner circumferential surfaces of axially opposite ends of the main rubber elastic body 42 where the mass installation grooves 22 are formed and the outer circumferential surface of the arm 12 continuously over an entire circumference thereof. The dimensions δ3 and δ4 are arranged to meet the condition “δ3<δ4”.

In other words, in this embodiment, an abutting inner surface 46 is formed including the inner circumferential surface of the axially central portion of the main rubber elastic body 42 (the inner circumferential surface between the pair of mass installation grooves 22, 22 formed axially apart from each other), which is radially opposed to the outer circumferential surface of the abutting ring 44. The abutting inner surface 46 has the radial distance with respect to the outer circumferential surface of the arm 12 smaller than that of areas where the mass installation grooves 22 are formed, while coming into abutting contact against the arm 12 during resilient displacement in an axis-perpendicular direction relative to the arm 12.

In the vibration-damping device 40 constructed as described above, the main rubber elastic body 42 is mounted around the arm 12 through the slit 30 from the radially outer side of the arm 12 and then the mass member 18 is fitted onto the mass installation groove 22 of the main rubber elastic body 42 installed around the arm 12, while being fixed to the outer circumferential surface of the main rubber elastic body 42 with no adhesive therebetween. Accordingly, like the vibration-damping device 10 of the first embodiment, the vibration-damping device 40 can advantageously achieve improvement both in ease of installation to the arm 12 and in tuning performance with respect to vibration frequency band to be damped.

In this embodiment in particular, the vibration-damping device 40 is provided with the pair of mass members 18, thereby further advantageously exhibiting vibration damping action on the basis of power of the mass members 18.

In addition, the main rubber elastic body 42 is of cylindrical shape extending straightly, making construction of the mold simple as well as reducing occurrence of strain in recesses and protrusions during vulcanization molding. Therefore, the vibration-damping device 40 is able to obtain enhanced durability.

Furthermore, in this embodiment, the abutting inner surface 46 of the main rubber elastic body 42 comes into abutment with the arm 12 via the abutting ring 44 secured to the arm 12. Accordingly, tuning performance of the vibration-damping device 40 can be further improved by modifying shape, size, construction or other aspects of the abutting ring 44.

While the present invention has been described in detail in its presently preferred embodiment, for illustrative purpose only, it is to be understood that the invention is by no means limited to the details of the illustrated embodiment, but may be otherwise embodied. It is also to be understood that the present invention may be embodied with various changes, modifications and improvements which may occur to those skilled in the art, without departing from the spirit and scope of the invention.

For example, the shape, size, construction, number, location, and other aspects of the mass member 18, the main rubber elastic body 16, the mass installation groove 22, the abutting inner surface 28, or slit 30 can be modified appropriately depending on the required vibration damping characteristics, ease of fabrication, ease of installation and given space for installation, and are not limited to those taught hereinabove by way of example.

FIG. 8 shows a vibration-damping structure 71 including a cylindrical vibration-damping device 70 constructed according to a third embodiment of the invention which is mounted around the arm 12. Specifically, as shown in FIG. 8 for example, the main rubber elastic body 16 may be provided with a plurality of the mass installation grooves 22 (in this embodiment, three) positioned axially apart from one another and each having the mass member 18 fixed thereto. With this arrangement, the abutting inner surfaces 28 are formed between areas where the mass installation grooves 22, 22 which are axially adjacent to each other are formed. In addition, the abutting inner surfaces 28 are further formed axially outward from the mass installation grooves 22 positioned near the axially opposite ends of the main rubber elastic body 16. That is, the abutting inner surface 28 is formed on axially either side of the each mass installation groove 22.

Besides, as shown in FIG. 8, the shape, dimension or other aspects of each of the mass installation grooves 22 or each of the mass members 18 may be varied from one another, thereby improving tuning properties of the vibration-damping device 70.

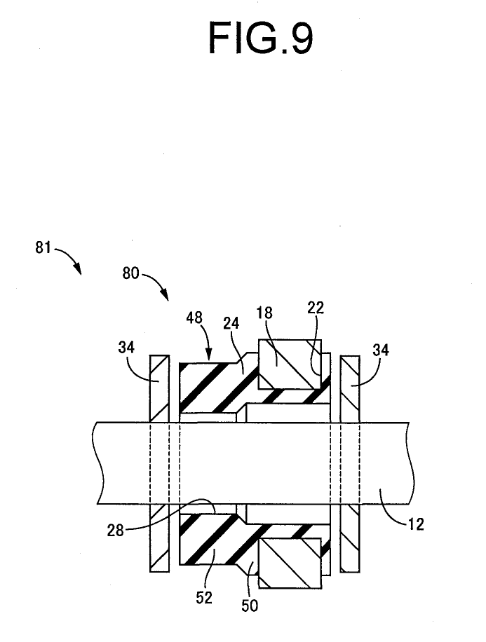

FIG. 9 shows a vibration-damping structure 81 including a cylindrical vibration-damping device 80 constructed according to a fourth embodiment of the invention which is mounted around the arm 12. As shown in FIG. 9, it could also be possible that a main rubber elastic body 48 of cylindrical shape includes: the tapered portion 24 at its axially central portion; a large-diameter cylindrical portion 50 on axially one side of the tapered portion 24; a small-diameter cylindrical portion 52 having a smaller diameter than that of the large-diameter cylindrical portion 50 on axially the other side of the tapered portion 24; and the mass installation groove 22 opening in an outer circumferential surface of the large-diameter cylindrical portion 50 and having the mass member 18 fixed thereto. In the vibration-damping device 80, an inner circumferential surface of the small-diameter cylindrical portion 52 forms the abutting inner surface 28 of the main rubber elastic body 48 adapted to come into abutting contact against the arm 12.

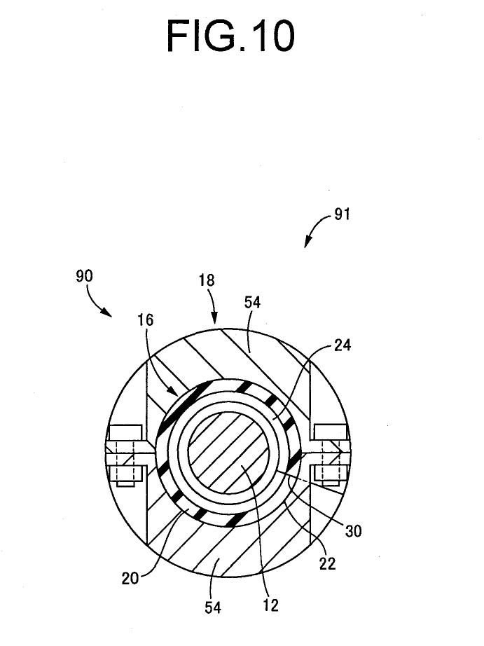

In the first through fourth embodiments described above, the step of preparing the mass member 18 comprises the step of preparing the mass member 18 having the opening 32 in one circumferential position thereof so as to have the C-letter shaped cross section in the axis-perpendicular direction; and the step of fixing the mass member 18 to the main rubber elastic body 16 comprises the steps of fitting the mass member 18 onto the mass installation groove 22 of the main rubber elastic body 16 from the radially outer side thereof while inserting the cylindrical center portion 20 of the main rubber elastic body 16 into the inside of the mass member 18 through the opening 32, and executing the diameter reducing operation on the mass member 18 in order to fix the mass member 18 to the outer circumferential surface of the main rubber elastic body 16 with no adhesive therebetween. However, these steps are not limited to the exemplary embodiments. FIG. 10 shows a vibration-damping structure 91 including a cylindrical vibration-damping device 90 constructed according to a fifth embodiment of the invention which is mounted around the arm 12. As shown in FIG. 10, for example, the step of preparing the mass member 18 may comprise the step of preparing the mass member 18 including a plurality of segmented mass members 54 (in this example, two) each having generally arc-shaped cross section in an axial direction and serving as segmented bodies, and the step of fixing the mass member 18 to the main rubber elastic body 16 may comprise the steps of fitting each segmented mass member 54 onto the mass installation groove 22 from the radially outer side thereof so as to be butted at each other, by securing circumferentially butted portions of the segmented mass members 54 with bolts and nuts, thereby forming the mass member 18 constructed of the segmented mass members 54 fixedly connected to each other in the circumferential direction.

Besides, whereas in the first through fifth embodiments described above the stopper member 34 are employed as a positioning means in order to dispose the vibration-damping devices 10, 40, 70, 80, and 90 to the intended position of the arm 12 where vibration to be damped is excited, the positioning means is not limited to the exemplary embodiments.

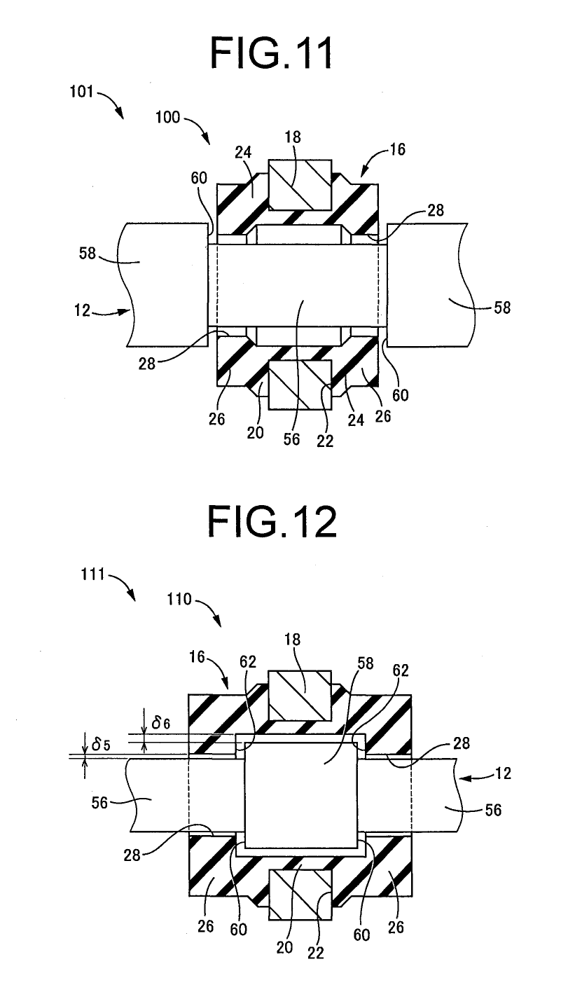

FIG. 11 shows a vibration-damping structure 101 including a cylindrical vibration-damping device 100 constructed according to a sixth embodiment of the invention which is mounted around the arm 12. As shown in FIG. 11, for example, the arm 12 may have a small-diameter portion 56 with a small diameter dimension formed at a certain area and large-diameter portions 58 formed on either side of the small-diameter portion 56. The main rubber elastic body 16 having the axial length smaller than a longitudinal dimension of the small-diameter portion 56 is mounted around the small-diameter portion 56 with the slit 30 opened, while the axially opposite ends of the main rubber elastic body 16 are axially opposed to annular shoulder portions 60 formed at boundaries between the small-diameter portion 56 and each of the large-diameter portions 58. An inside diameter dimension of each cylindrical end portion 26 formed at axially either end portion of the main rubber elastic body 16 is made smaller than an outside diameter dimension of each shoulder portion 60 (a diameter dimension of each large-diameter portion 58), so that the shoulder portions 60, 60 are able to serve as positioning means of the vibration-damping device 100.

FIG. 12 shows a vibration-damping structure 111 including a cylindrical vibration-damping device 110 constructed according to a seventh embodiment of the invention which is mounted around the arm 12. Alternatively, as shown in FIG. 12, the arm 12 may have a large-diameter portion 58 with a large diameter dimension formed at a certain area and small-diameter portions 56 formed on either side of the large-diameter portion 58. The main rubber elastic body 16 includes the cylindrical center portion 20 having the axial length larger than a longitudinal dimension of the large-diameter portion 58 and annular inner walls 62 formed at boundaries between the inner circumferential surface of the cylindrical center portion 20 and each of the abutting inner surfaces 28 while extending in the axis-perpendicular direction. The main rubber elastic body 16 is mounted around the large-diameter portion 58 with the slit 30 opened, while the inner walls 62 are axially opposed to annular shoulder portions 60 formed at the boundaries between the large-diameter portion 58 and each of the small-diameter portions 56. The inside diameter dimension of each cylindrical end portion 26 formed at axially either end portion of the main rubber elastic body 16 is made smaller than the outside diameter dimension of each shoulder portion 60, so that the shoulder portions 60, 60 are able to serve as positioning means of the vibration-damping device 110. As shown in FIG. 12, in this embodiment, with the vibration-damping device 110 and the arm 12 being placed in a concentric fashion, there is provided a radial space of given dimension: δ5 between the abutting inner surface 28 of the main rubber elastic body 16 and an outer circumferential surface of each of the small-diameter portions 56 of the arm 12 continuously over an entire circumference thereof, while there is provided a radial space of given dimension: δ6 between the inner circumferential surface of the cylindrical center portion 20 of the main rubber elastic body 16 and an outer circumferential surface of the large-diameter portion 58 of the arm 12 continuously over an entire circumference thereof. The dimensions δ5 and δ6 are arranged to meet the condition “δ5<δ6”.

As shown in FIGS. 11 and 12, in the case where the vibration-damping device 100, 110 is mounted on the arm 12 having a changing cross section in an axis-perpendicular direction across the entire length thereof, if the main rubber elastic body 16 has no slit 30, for example, it should be difficult to insert the large-diameter portion 58 of the arm 12 into the cylindrical end portion 26 of the main rubber elastic body 16 and move the main rubber elastic body 16 in the axial direction since the inside diameter dimension of each of the cylindrical end portion 26 including the abutting inner surface 28 inside is made smaller than a diameter dimension of the large-diameter portion 58 of the arm 12. With this respect, in the present embodiment, by opening the slit 30 formed in the main rubber elastic body 16 so as to make the inside diameter dimension of each of the cylindrical end portion 26 larger than the diameter dimension of the large-diameter portion 58, it would be possible to insert the large-diameter portion 58 into the cylindrical end portion 26 and move the main rubber elastic body 16 in the axial direction, or to directly mount the main rubber elastic body 16 around the small-diameter portion 56 of the arm 12 through the slit 30 from the radially outer side thereof, making the installation of the vibration-damping device 100, 110 extremely easy.

Whereas in the first through seventh embodiments described above the slit 30 appears to be of generally linear shape extending parallel to the axial direction of the main rubber elastic body 16, the slit 30 may alternatively extend diagonally or in a helical configuration over the circumference of the main rubber elastic body 16. This arrangement makes it possible to further advantageously prevent a risk that the main rubber elastic body 16 will drop off the arm 12 through the slit 30.

Also, the opening 32 of the mass member 18 is not an essential element of the invention. For example, it could also be possible to employ the mass member 18 of annular shape having a large diameter depending on the required ease of fabrication or installation condition. When installing this annular-shaped mass member 18, the procedure includes: to first fit the mass member 18 externally from the end of the arm 12 in the axial direction, to then fit the mass member 18 externally from one of the cylindrical end portions 26 of the main rubber elastic body 16 in the axial direction, to then place the bottom surface of the mass installation groove 22 and the inner circumferential surface of the mass member 18 radially in opposition to each other, to then execute a diameter reducing operation on the mass member 18, so that the mass member 18 is fitted onto the mass installation groove 22 so as to be fixed to the main rubber elastic body 16.

In the second embodiment described above, the abutting inner surface 46 is formed by the inner circumferential surface of the central portion of the main rubber elastic body 42 (the inner circumferential surface between the areas where the pair of the mass installation grooves 22, 22, are formed) radially opposed to the abutting ring 44 secured to the arm 12. Alternatively, for example, a plurality of the abutting inner surfaces 46 may be formed by forming the mass installation groove 22 at axially central portion of the main rubber elastic body 42 while securing a pair of the abutting rings 44 to the arm 12 with being spaced apart from each other by a prescribed distance. With this arrangement, with respect to the inner circumferential surface of the main rubber elastic body 42, each inner circumferential surface on either side of the area where the mass installation groove 22 is formed is radially opposed to each abutting ring 44, thereby forming the abutting inner surface 46.

Additionally, in the preceding embodiments, the vibration-damping devices 10, 40, 70, 80, 90, 100 and 110 are described as being adopted as a vibration-damping device for the arm 12 serving as a vibrating member and employed as a suspension member of an automotive vehicle, the vibration-damping devices 10, 40, 70, 80, 90, 100 and 110 according to the present invention could of course be applicable to, for example, stabilizers, side door beams, steering shafts, steering columns, steering rods, or pipes, hoses such as conduits of an air conditioner, or other various kinds of solid or hollow rod shaped vibrating members for use in devices other than automotive vehicles.

What is claimed is:

1. A method of producing an impact-type cylindrical vibration-damping device comprising the steps of:
preparing a main rubber elastic body of hollow cylindrical shape such that the main rubber elastic body includes a mass installation groove open in an outer circumferential surface thereof and extending in a circumferential direction thereof, and has a slit formed at one circumferential position while extending over an entire axial length thereof;
expanding the main rubber elastic body at the slit in order to mount the main rubber elastic body about a rod shaped vibrating member whose vibration to be damped through the slit from a radially outer side of the rod shaped vibrating member such that an entire inner circumferential surface of the main rubber elastic body is radially spaced away from an outer circumferential surface of the rod shaped vibrating member, and a radial distance between the inner circumferential surface of the main rubber elastic body and the outer circumferential surface of the rod shaped vibrating member is made smallest at a portion which is remote from the mass installation groove in an axial direction of the main rubber elastic body in order to form an abutting inner surface adapted to come into abutting contact against the rod shaped vibrating member,
preparing a mass member separately from the main rubber elastic body; and
fixing the mass member to the main rubber elastic body by fitting the mass member onto the mass installation groove of the main rubber elastic body.

2. The method of producing the impact-type cylindrical vibration-damping device according to claim 1, wherein the step of fixing the mass member comprises the step of fitting the mass member onto an outer circumferential surface of the mass installation groove with no adhesive therebetween.

3. The method of producing the impact-type cylindrical vibration-damping device according to claim 1, wherein the step of preparing the mass member comprises the step of preparing the mass member in a C-letter shape to have an opening in one circumferential position thereof; and wherein the step of fixing the mass member to the main rubber elastic body further comprising the steps of installing the mass member around the mass installation groove of the main rubber elastic body through the opening of the mass member, and executing a diameter reducing operation on the mass member installed around the main rubber elastic body in order to fix the mass member onto the mass installation groove of the main rubber elastic body.

4. The method of producing the impact-type cylindrical vibration-damping device according to claim 1, wherein the step of preparing the mass member comprising the step of preparing the mass member including a plurality of segmented bodies, and wherein the step of fixing the mass member to the main rubber elastic body further comprising the steps of fitting the plurality of segmented bodies of the mass member onto the mass installation groove so as to be fixedly connected to one another in the circumferential direction.

5. An impact-type cylindrical vibration-damping device comprising:
a main rubber elastic body of hollow cylindrical shape adapted to be mounted around a rod shaped vibrating member such that an entire inner circumferential surface of the main rubber elastic body is radially spaced away from an outer circumferential surface of the rod shaped vibrating member, the main rubber elastic body including at least one mass installation groove open in an outer circumferential surface while extending in a circumferential direction thereof, and a slit formed at one circumferential position while extending over an entire axial length thereof; and
at least one mass member formed as a separate element from the main rubber elastic body and fixed to the main rubber elastic body by being fitted onto the mass installation groove,
wherein an abutting inner surface adapted to come into abutting contact against the rod shaped vibrating member during resilient displacement in an axis-perpendicular direction relative to the rod shaped vibrating member is formed at a position in the inner circumferential surface of the main rubber elastic body which is spaced away in an axial direction from the mass installation groove to which the mass member is fixed, and a radial distance between the abutting inner surface of the main rubber elastic body and the outer circumferential surface of the rod shaped vibrating member is made smaller than a radial distance between an inner surface of an area of the main rubber elastic body where the mass installation groove is formed and the outer circumferential surface of the rod shaped vibrating member.

6. An impact-type cylindrical vibration-damping device according to claim 5, wherein the mass member is fitted onto an outer circumferential surface of the mass installation groove with no adhesive therebetween.

7. An impact-type cylindrical vibration-damping device according to claim 5, wherein the mass member installed around the mass installation groove is subjected to a diameter reducing operation and thereby fixed onto the mass installation groove.

8. An impact-type cylindrical vibration-damping device according to claim 7, wherein the mass member has a C-letter shaped cross section in the axis-perpendicular direction with an opening formed in one circumferential position thereof.

9. An impact-type cylindrical vibration-damping device according to claim 5, wherein the mass member includes a plurality of segmented bodies fixedly connected to one another in the circumferential direction.

10. An impact-type cylindrical vibration-damping device according to claim 5, wherein at least one mass installation groove comprises a plurality of the mass installation grooves positioned axially apart from one another, and at least one mass member comprises a plurality of the mass members fixed to the plurality of the mass installation grooves, respectively, and wherein the abutting inner surface is formed on axially either side of the each mass installation groove.

11. An impact-type cylindrical vibration-damping device according to claim 5, wherein the main rubber elastic body further includes: a tapered portion at an axially central portion thereof; a large-diameter cylindrical portion on axially one side of the tapered portion; a small-diameter cylindrical portion on axially an other side of the tapered portion, wherein the mass installation groove is formed opening in an outer circumferential surface of the large-diameter cylindrical portion and having the mass member fixed thereto, and wherein an inner circumferential surface of the small-diameter cylindrical portion forms the abutting inner surface.

12. A vibration-damping structure including an impact-type cylindrical vibration-damping device comprising:
a main rubber elastic body of hollow cylindrical shape including at least one mass installation groove open in an outer circumferential surface while extending in a circumferential direction thereof, and a slit formed at one circumferential position while extending over an entire axial length thereof, the main rubber elastic body being mounted around a rod shaped vibrating member such that an entire inner circumferential surface of the main rubber elastic body is radially spaced away from an outer circumferential surface of the rod shaped vibrating member; and
at least one mass member formed as a separate element from the main rubber elastic body and fixed to the main rubber elastic body by being fitted onto the mass installation groove,
wherein an abutting inner surface adapted to come into abutting contact against the rod shaped vibrating member during resilient displacement in an axis-perpendicular direction relative to the rod shaped vibrating member is formed at a position in the inner circumferential surface of the main rubber elastic body which is remote in an axial direction from the mass installation groove to which the mass member is fixed, and a radial distance between the abutting inner surface of the main rubber elastic body and the outer circumferential surface of the rod shaped vibrating member is made smaller than a radial distance between an inner surface of an area of the main rubber elastic body where the mass installation groove is formed and the outer circumferential surface of the rod shaped vibrating member.

13. A vibration-damping structure according to claim 12, wherein: the main rubber elastic body has an inside diameter dimension substantially unchanging overall; the rod shaped vibrating member has an abutting ring secured thereto; and the abutting inner surface includes an area of the inner circumferential surface of the main rubber elastic body which is radially opposed to an outer circumferential surface of the abutting ring.

14. A vibration-damping structure according to claim 12, wherein:
the rod shaped vibrating member including: a small-diameter portion formed at a certain area; large-diameter portions formed on axially either side of the small-diameter portion; and annular shoulder portions formed at boundaries between the small-diameter portion and each of the large-diameter portions;
the main rubber elastic body has the axial length smaller than a longitudinal dimension of the small-diameter portion of the rod shaped vibrating member; and
an inside diameter dimension of each cylindrical end portion formed at axially either end portion of the main rubber elastic body is made smaller than an outside diameter dimension of each of the shoulder portions so that the shoulder portions serve as positioning means of the vibration-damping device.

15. A vibration-damping structure according to claim 12, wherein:
the rod shaped vibrating member including: a large-diameter portion formed at a certain area; small-diameter portions formed on axially either side of the large-diameter portion; and annular shoulder portions formed at boundaries between the large-diameter portion and each of the small-diameter portions;
the main rubber elastic body has a central portion having an inside diameter larger than an outside diameter of the large-diameter portion of the vibrating member, while extending over an axial length larger than the large-diameter portion of the vibrating member; and has cylindrical end portions formed at axially either end of the main rubber elastic body whose inside diameter dimension is made smaller than an outside diameter dimension of each of the shoulder portions of the rod shaped vibrating member so that the shoulder portions serve as positioning means of the vibration-damping device.
